(19) United States
(12) Patent Application Publication
(10) Pub. No.: US 2026/0017339 A1
(43) Pub. Date: Jan. 15, 2026

(54) MATRIX-VECTOR MULTIPLICATION CIRCUIT AND CIRCUIT CONFIGURING METHOD OF THE SAME

(71) Applicant: MACRONIX INTERNATIONAL CO., LTD., HSINCHU (TW)

(72) Inventor: Yu-Yu LIN, New Taipei City (TW)

(21) Appl. No.: 18/766,706

(22) Filed: Jul. 9, 2024

(51) Int. Cl. G06F 17/16

(52) U.S. Cl. CPC G06F 17/16

(57) ABSTRACT

A matrix-vector multiplication circuit configured to represent a plurality of weight values is provided. The matrix-vector multiplication circuit comprises a plurality of resistor strings, and each resistor string comprises a plurality of weight units. The resistor strings are coupled between two reference voltages in parallel. For each resistor string, the weight units are coupled between the two reference voltages in series. The weight units form a plurality of combinations corresponding to the weight values. For each combination, the weight units have the same order in the plurality of resistor strings respectively. Each weight unit has a status value, the status values of the weight units in the plurality of combinations form a plurality of sequences respectively corresponding to the weight values. The weight units corresponding to the most significant bits of the sequences are located in at least two of the resistor strings.

### BACKGROUND

### Technical Field

The present disclosure is related to the configuration technology of resistances of matrix-vector multiplication circuits. More particularly, the present disclosure is related to the matrix-vector multiplication circuits that can improve the linearity of the output and the circuit configuring method of the same.

### Description of Related Art

As the computing load of today's semiconductor devices increases day by day, how to configure the matrix circuits in the memory device has become one of the key points when designing the memory device. Among various configurations of the matrix circuit, the mixing-mode matrix-vector multiplication (MVM) circuit structure is widely used because it can handle a large amount of computing of input data and weight values.

In order to ensure correct computing results, the memory device needs to be able to accurately calculate the equivalent resistance of the matrix circuit to generate accurate outputs. However, in today's configurations of mixed-mode MVM circuits, the weight values in the circuits are usually unevenly distributed. In other words, in today's configurations, the outputs of the mixed-mode MVM circuits are not linear enough, resulting in a deviation between the estimated resistance and the actual resistance, and may result in inaccurate outputs. Therefore, how to improve the linearity of the outputs of the mixed-mode MVM circuit by adjusting its configuration is one of the topics in this field.

### SUMMARY

A matrix-vector multiplication circuit is provided in the present disclosure. The matrix-vector multiplication circuit is configured to represent a plurality of weight values and comprises a plurality of resistor strings, and each of the plurality of resistor strings comprises a plurality of weight units. The plurality of resistor strings are coupled between two reference voltages in parallel. For each of the plurality of resistor strings, the plurality of weight units are coupled between the two reference voltages in series. The plurality of weight units form a plurality of combinations corresponding to the plurality of weight values. For each of the plurality of combinations, the plurality of weight units have the same order in the plurality of resistor strings respectively. Each of the plurality of weight units has a status value, and the plurality of status values of the plurality of weight units in the plurality of combinations form a plurality of sequences respectively corresponding to the plurality of weight values. The plurality of weight units corresponding to a plurality of most significant bits of the plurality of sequences are located in at least two of the plurality of resistor strings.

In some embodiments of the matrix-vector multiplication circuit, the plurality of weight units respectively corresponding to the plurality of most significant bits of a plurality of odd sequences of the plurality of sequences are located in one of the plurality of resistor strings, and the plurality of weight units respectively corresponding to the plurality of most significant bits of a plurality of even sequences of the plurality of sequences are located in another of the plurality of resistor strings. The plurality of odd sequences are different from the plurality of even sequences.

In some embodiments of the matrix-vector multiplication circuit, the plurality of weight units corresponding to the plurality of most significant bits of the plurality of odd sequences and the plurality of weight units corresponding to a plurality of least significant bits of the plurality of even sequences are located in the same one of the plurality of resistor strings. The plurality of weight units corresponding to the plurality of most significant bits of the plurality of even sequences and the plurality of weight units corresponding to a plurality of least significant bits of the plurality of odd sequences are located in another same one of the plurality of resistor strings.

In some embodiments of the matrix-vector multiplication circuit, the plurality of weight units of the plurality of combinations corresponding to the plurality of odd sequences and the plurality of weight units of the plurality of combinations corresponding to the plurality of even sequences are arranged alternately in the plurality of resistor strings.

In some embodiments of the matrix-vector multiplication circuit, each of the plurality of status values of the plurality of weight units is of a bit value “0” or a bit value “1”, and the plurality of weight values correspond to the numbers of the weight unit having the status value of the bit value “1” in the plurality of combinations respectively.

In some embodiments of the matrix-vector multiplication circuit, the plurality of the sequences are of unary code arrays, and each of the plurality of weight values corresponds to the number of the consecutive bit value “1” starting from the most significant bit in corresponding one of the plurality of sequences.

In some embodiments of the matrix-vector multiplication circuit, the weight unit corresponding to a least significant bit of one of the plurality of sequences and the weight unit corresponding to the most significant bit of adjacent one of the plurality of sequences are located in the same one of the plurality of resistor strings.

In some embodiments of the matrix-vector multiplication circuit, the matrix-vector multiplication circuit further comprises a control circuit configured to generate a plurality of input signals to the plurality of weight units respectively. Each of the plurality of weight units has a resistance related to the status value and related to the plurality of input signals.

In some embodiments of the matrix-vector multiplication circuit, each of the plurality of resistor strings further comprises an additional resistor coupled to the plurality of weight units in series and configured to prevent the plurality of resistor strings from performing fast charging behavior.

In some embodiments of the matrix-vector multiplication circuit, each of the plurality of weight units and the additional resistor has a resistance, and the resistance of the additional resistor is approximately equal to or greater than the resistance of each of the plurality of weight units.

A circuit configuring method is provided in the present disclosure. The circuit configuring method is configured to configure a matrix-vector multiplication circuit. The matrix-vector multiplication circuit comprises a control circuit and a plurality of resistor strings coupled between two reference voltages in parallel, and each of the plurality of resistor strings comprises a plurality of weight units coupled between the two reference voltages in series. The circuit configuring method comprises: setting, by the control circuit, a plurality of weight values of the matrix-vector multiplication circuit; determining, by the control circuit, a plurality of sequences based on the plurality of weight values, wherein the plurality of sequences respectively correspond to the plurality of weight values; and setting, by the control circuit, a status value of each of the plurality of weight units based on the plurality of sequences. The plurality of weight units form a plurality of combinations corresponding to the plurality of weight values, and for each of the plurality of combinations, the plurality of weight units have the same order in the plurality of resistor strings respectively. The plurality of weight units corresponding to a plurality of most significant bits of the plurality of sequences are located in at least two of the plurality of resistor strings.

In some embodiments of the circuit configuring method, determining, by the control circuit, the plurality of sequences based on the plurality of weight values comprises: dividing, by the control circuit, the plurality of sequences into a plurality of odd sequences and a plurality of even sequences. The plurality of weight units respectively corresponding to the plurality of most significant bits of the plurality of odd sequences are located in one of the plurality of resistor strings, and the plurality of weight units respectively corresponding to the plurality of most significant bits of the plurality of even sequences are located in another of the plurality of resistor strings. The plurality of odd sequences are different from the plurality of even sequences.

In some embodiments of the circuit configuring method, the plurality of weight units corresponding to the plurality of most significant bits of the plurality of odd sequences and the plurality of weight units corresponding to a plurality of least significant bits of the plurality of even sequences are located in the same one of the plurality of resistor strings. The plurality of weight units corresponding to the plurality of most significant bits of the plurality of even sequences and the plurality of weight units corresponding to a plurality of least significant bits of the plurality of odd sequences are located in another same one of the plurality of resistor strings.

In some embodiments of the circuit configuring method, the plurality of weight units of the plurality of combinations corresponding to the plurality of odd sequences and the plurality of weight units of the plurality of combinations corresponding to the plurality of even sequences are arranged alternately in the plurality of resistor strings.

In some embodiments of the circuit configuring method, setting, by the control circuit, the status value of each of the plurality of weight units based on the plurality of sequences comprises: setting, by the control circuit, the plurality of status values of the plurality of weight units to a bit value “0” or a bit value “1”. The plurality of weight values correspond to the numbers of the weight unit having the status value of the bit value “1” in the plurality of combinations respectively.

In some embodiments of the circuit configuring method, the plurality of the sequences are of unary code arrays, and each of the plurality of weight values corresponds to the number of the consecutive bit value “1” starting from the most significant bit in corresponding one of the plurality of sequences.

In some embodiments of the circuit configuring method, the weight unit corresponding to a least significant bit of one of the plurality of sequences and the weight unit corresponding to the most significant bit of adjacent one of the plurality of sequences are located in the same one of the plurality of resistor strings.

In some embodiments of the circuit configuring method, each of the plurality of weight units has a resistance related to the status value, and setting, by the control circuit, the status value of each of the plurality of weight units based on the plurality of sequences comprises: generating, by the control circuit, a plurality of input signals to the plurality of weight units, to control the resistance of each of the plurality of weight units.

In some embodiments of the circuit configuring method, each of the plurality of resistor strings further comprises an additional resistor coupled to the plurality of weight units in series. The circuit configuring method further comprises: setting, by the control circuit, a resistance of the additional resistor, to prevent the plurality of resistor strings from performing fast charging behavior.

In some embodiments of the circuit configuring method, each of the plurality of weight units has a resistance, and the resistance of the additional resistor is approximately equal to or greater than the resistance of each of the plurality of weight units.

With the matrix-vector multiplication circuit and the circuit configuring method in the present disclosure, the weight values of the circuit can be configured more evenly, thereby improving the linearity of the output of the matrix-vector multiplication circuit and outputting more accurate operation results.

It should be understood that both the foregoing general description and the following detailed description are by examples, and are intended to provide further explanation of the disclosure as claimed.

### BRIEF DESCRIPTION OF THE DRAWINGS

The present disclosure can be more fully understood by reading the following detailed description of the embodiment, with reference made to the accompanying drawings as follows.

FIG. 1 is a schematic diagram of a matrix-vector multiplication circuit in accordance with some embodiments of the present disclosure.

FIG. 2 is a schematic diagram of the relationship between the matrix-vector multiplication circuit and weight values in accordance with some embodiments of the present disclosure.

FIG. 3A is a schematic diagram of a configuration of the status values of the matrix-vector multiplication circuit in accordance with some instances.

FIG. 3B is a schematic diagram of a configuration of the status values of the matrix-vector multiplication circuit in accordance with some embodiments of the present disclosure.

FIG. 3C is a schematic diagram of a configuration of the status values of the matrix-vector multiplication circuit in accordance with some embodiments of the present disclosure.

FIG. 3D is a schematic diagram of a configuration of the status values of the matrix-vector multiplication circuit in accordance with some embodiments of the present disclosure.

FIG. 4 is a schematic diagram of the relationship between the equivalent resistance and the estimated resistance of various configurations in accordance with some embodiments of the present disclosure.

FIG. 5 is a schematic diagram of a matrix-vector multiplication circuit in accordance with some embodiments of the present disclosure.

FIG. 6 is a flowchart of a circuit configuring method in accordance with some embodiments of the present disclosure.

### DETAILED DESCRIPTION

Reference will now be made in detail to the present embodiments of the disclosure, examples of which are illustrated in the accompanying drawings.

In the present disclosure, when an element is referred to as “connected”, it may mean “electrically connected” or “optical connected”. When an element is referred to as “coupled”, it may mean “electrically coupled” or “optical coupled”. “Connected” or “coupled” can also be used to indicate that two or more components operate or interact with each other. As used in the present disclosure, the singular forms “a”, “one” and “the” are also intended to include plural forms, unless the context clearly indicates otherwise. It will be further understood that when used in this specification, the terms “comprises (comprising)” and/or “includes (including)” designate the existence of stated features, steps, operations, elements and/or components, but the existence or addition of one or more other features, steps, operations, elements, components, and/or groups thereof are not excluded.

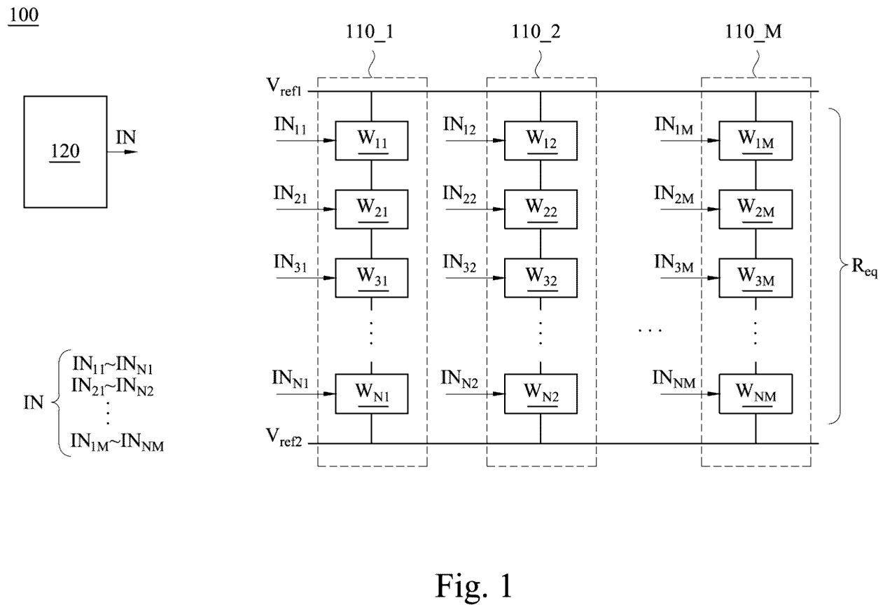

FIG. 1 is a schematic diagram of a matrix-vector multiplication circuit 100 in accordance with some embodiments of the present disclosure. In some embodiments, the matrix-vector multiplication circuit 100 comprises resistor strings 110_1-110_M and a control circuit 120, and is configured to represent a plurality of input values. The way that the matrix-vector multiplication circuit 100 represents the plurality of weight values will be described in following paragraphs in detail.

Each of the resistor strings 110_1-110_M comprises a plurality of weight units. For example, the resistor string 110_1 comprises weight units W₁₁-W_{N1}, the resistor string 110_2 comprises weight units W₁₂-W_{N2}, the resistor string 110_M comprises weight units W_{1M}-W_{NM}, and so on, wherein N and M are positive integers. In some embodiments, the resistor strings 110_1-110_M are coupled between reference voltages V_{ref1} and V_{ref2} in parallel, and the weight units of each of the resistor strings (e.g., the weight units W₁₁-W_{N1} for the resistor string 110_1) are coupled between the reference voltages V_{ref1} and V_{ref2} in series, thereby forming the architecture of a matrix circuit.

In some embodiments, each of the weight units has a status value (e.g., a bit value “0” or a bit value “1” in two-bit mode, or a bit value “0”, a bit value “1”, a bit value “2”, etc. in multi-bit mode), and this status value determines the resistance of the weight unit. For example, the weight unit having the status value of the bit value “1” has a higher resistance R_{H}, and the weight unit having the status value of the bit value “0” has a lower resistance R_{L}. Based on the resistances of the weight units coupled in series/parallel, the equivalent resistance R_{eq} of the matrix circuit can be determined.

In addition, the weight units are configured to receive input signals from the control circuit 120. For example, the weight units W₁₁-W_{N1} respectively receive the input signals IN₁₁-IN_{N1}, the weight units W₁₂-W_{N2} respectively receive the input signals IN₁₂-IN_{N2}, the weight units WIM-W_{NM} respectively receive the input signals IN_{1M}-IN_{NM}, and so on. The input signals received by each weight unit may affect their status values, thereby affecting their resistances and the equivalent resistance R_{eq} of the matrix circuit.

The control circuit 120 is coupled to the weight units of the resistor strings 110_1-110_M, and is configured to generate the input signals IN₁₁-IN_{N1}, IN₁₂-IN_{N2} . . . and IN_{1M}-IN_{NM} (collectively referred to as “IN”) to the weight units of the resistor strings 110_1-110_M.

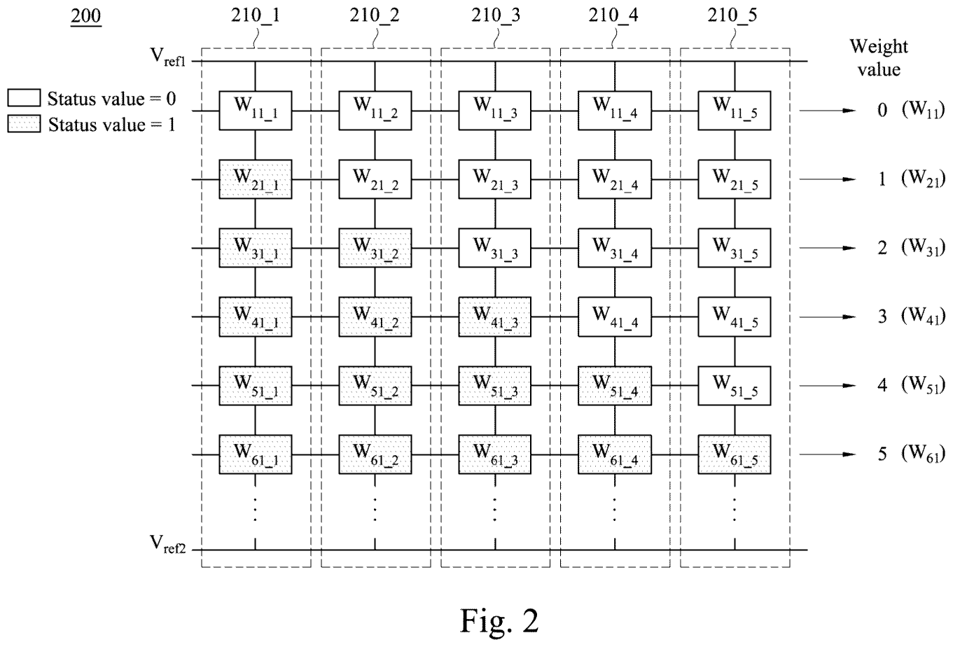

As mentioned above, in some embodiments, the matrix-vector multiplication circuit 100 is configured to represent a plurality of weight values. Please refer to FIG. 2. FIG. 2 is a schematic diagram of the relationship between a matrix-vector multiplication circuit 200 and weight values in accordance with some embodiments of the present disclosure. It should be noted that the matrix-vector multiplication circuit 200 of FIG. 2 is similar to the matrix-vector multiplication circuit 100 of FIG. 1, and thus its internal structure will not be repeated herein.

In some embodiments, the weight units having the same order in the resistor strings 210_1-210_5 form a combination, and this combination corresponds to the same weight value (i.e., the weight value corresponding to a certain weight unit in FIG. 1). For example, the weight units W_{11_1}, W_{11_2}, W_{11_3}, W_{11_4} and W_{11_5} at the top of the resistor strings 210_1-210_5 (i.e., closest to the reference voltage V_{ref1}) form a combination corresponding to the first weight value (i.e., the weight value corresponding to the weight unit W₁₁ in FIG. 1), the weight units W_{21_1}, W_{21_2}, W_{21_3}, W_{21_4} and W_{21_5} at the second top of the resistor strings 210_1-210_5 (i.e., second closest to the reference voltage V_{ref1}) form another combination corresponding to the second weight value (i.e., the weight value corresponding to the weight unit W₂₁ in FIG. 1), and so on.

Moreover, each of the weight values will determine the status values of the weight units of the corresponding combination. In some embodiments, the weight value can be represented by a unary code array. For example, the weight value 0 can be represented by a unary code array “00000”, the weight value 1 can be represented by a unary code array “10000”, the weight value 2 can be represented by a unary code array “11000”, the weight value 3 can be represented by a unary code array “11100”, the weight value 4 can be represented by a unary code array “11110”, and the weight value 5 can be represented by a unary code array “11111”. In other words, each weight value can be represented by a unary code array having a corresponding number of consecutive bit values “1” starting from the most significant bit.

Therefore, in the embodiments that the weight values are represented by unary code arrays, the array represented by the weight value can determine the status values of the weight units of the corresponding combination. Take the instance of FIG. 2 as an example, the first weight value (i.e., the weight value corresponding to the weight unit W₁₁ in FIG. 1) is 0, and thus the status values of the weight units W₁₁_1-W₁₁_5 are all 0; the second weight value (i.e., the weight value corresponding to the weight unit W₂₁ in FIG. 1) is 1, and thus the status values of the weight units W_{21_1}-W_{21_5} are 1; 0, 0, 0, 0 respectively; the third weight value (i.e., the weight value corresponding to the weight unit W₃₁ in FIG. 1) is 2, and thus the status values of the weight units W_{31_1}-W_{31_5} are 1; 1, 0, 0, 0 respectively; the fourth weight value (i.e., the weight value corresponding to the weight unit W₄₁) is 3, and thus the status values of the weight units W_{41_1}-W_{41_5} are 1; 1, 1, 0, 0 respectively; the fifth weight value (i.e., the weight value corresponding to the weight unit W₅₁) is 4, and thus the status values of the weight units W_{51_1}-W_{51_5} are 1; 1, 1, 1, 0 respectively; the sixth weight value (i.e., the weight value corresponding to the weight unit W₆₁) is 5, and thus the status values of the weight units W_{61_1}-W_{61_5} are all 1.

It should be noted that the aforementioned number of the status values of the weight units and the aforementioned encoding method of the weight values are only examples, and are not intended to limit the present disclosure. Other numbers of the status values of the weight units and other encoding methods of the weight values are within the scope of the present disclosure. In some embodiments, the weight units may have more than three different status values. In some embodiments, the weight values may be represented by binary arrays.

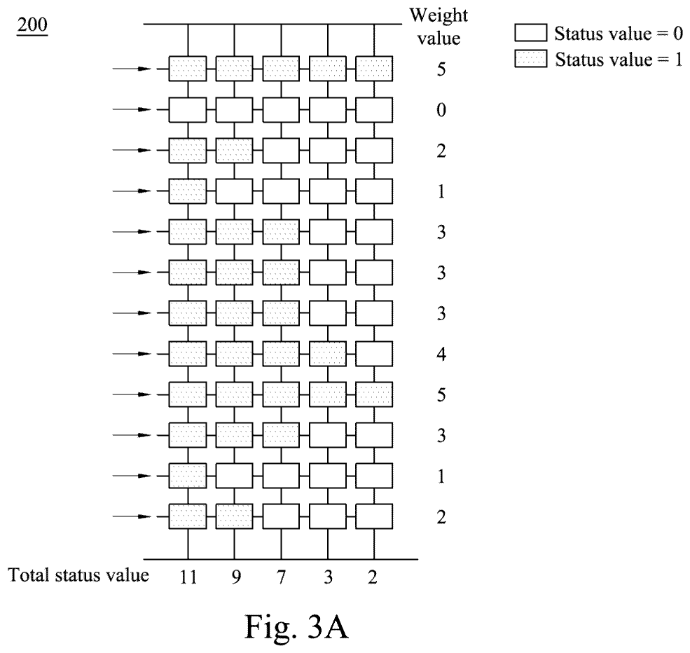

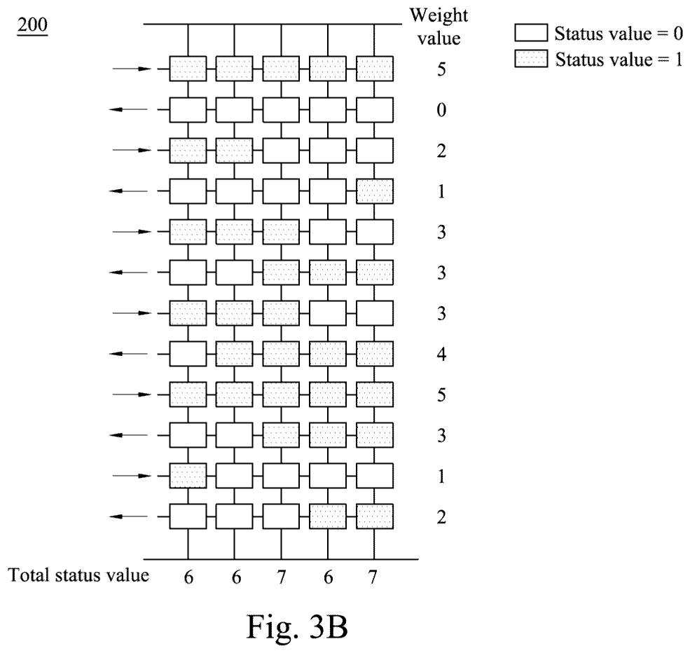

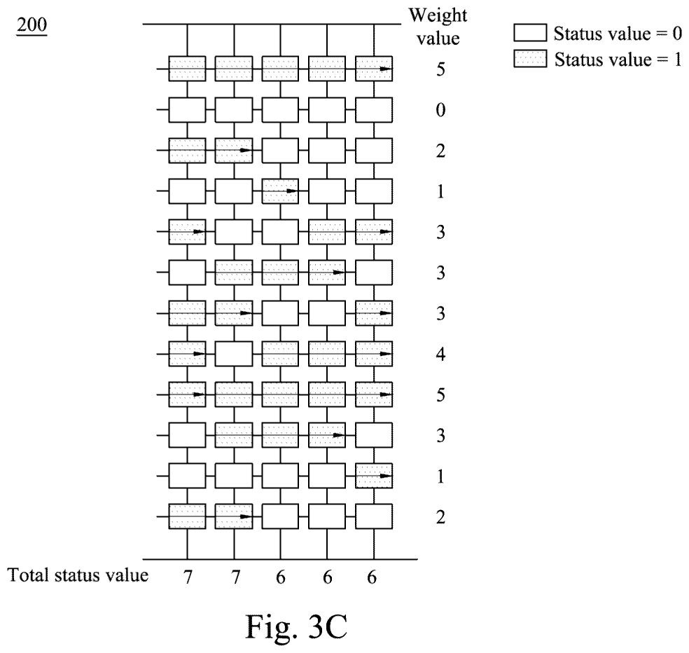

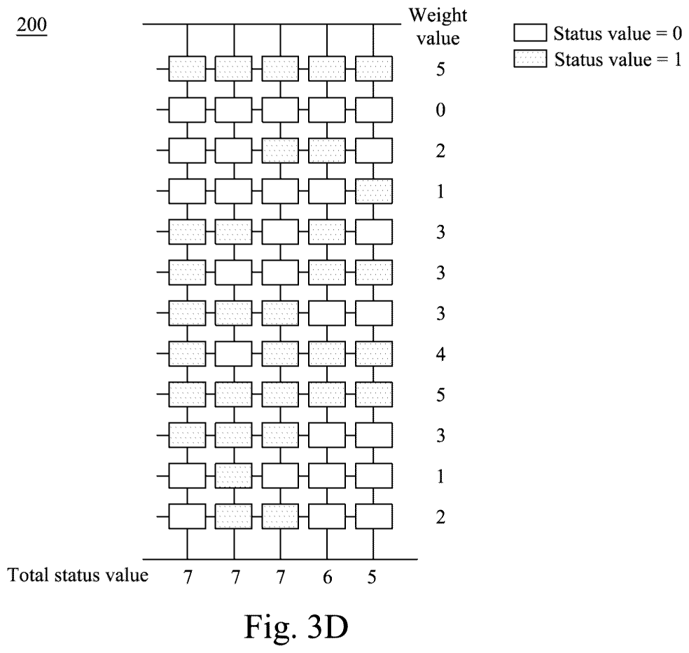

FIG. 3A is a schematic diagram of a configuration of the status values of the matrix-vector multiplication circuit 200 in accordance with some instances. It should be noted that for the sake of brevity, the labels of the transistor strings 210_1-210_5 and the weight units are omitted in FIGS. 3A-3D.

The instance in FIG. 3A is a common configuration of the status values of the weight units. Specifically, each weight value can be represented by a unary code array, the bits from the most significant bit (MSB) to the least significant bit (LSB) in this unary code array can be sequentially represented by the status values of the weight units in the corresponding combination, and the MSBs in each unary code array of each weight value is represented by the weight units of the same resistor string.

In FIGS. 3A-3C, the arrow symbols located next to each combination of weight units represent the order of the weight units corresponding to the MSB to LSB of the unary code array. Take the instance in FIG. 3A as an example. The first weight value is 5, which corresponds to a unary code array “11111”, and thus the status values of the weight units W_{11_1}-W_{11_5} are 1, 1, 1, 1, 1 in sequence; The third weight value is 2, which corresponds to a unary code array “11000”, and thus the status values of the weight units W_{31_1}-W_{31_5} are 1, 1, 0, 0, 0 in sequence. In other words, all bits in the unary code arrays are sequentially represented by the weight units in the resistor strings 210_1-210_5, so all MSBs correspond to the weight units of the resistor string 210_1.

As described above, based on the status value of the weight unit, the weight unit may have a higher resistance R_{H} or a lower resistance R_{L}. Therefore, due to the characteristic that bit value “1” in the unary code array is concentrated in the earlier bit, in the configuration of FIG. 3A, the sum of the status values of the resistor strings 210_1-210_5 is 11, 9, 7, 3 and 2, which shows a decreasing sequence and results in uneven distribution of resistances in the resistor strings 210_1-210_5. As shown in FIG. 2, since the resistor strings 210_1-210_5 are coupled between reference voltages V_{ref1} and V_{ref2} in parallel, when the resistances of the resistor strings 210_1-210_5 are unevenly distributed, the current will be concentrated on the resistor string with a smaller resistance (i.e., the resistor string 210_5), causing the current to be easily dominated by this resistor string, thereby affecting the overall circuit operation.

In order to solve the above problem, the present disclosure provides a variety of configurations of the status values of the matrix-vector multiplication circuit. Please refer to FIG. 1 again. The equivalent resistance R_{eq} of the matrix circuit formed by the resistor strings 110_1-110_M can be represented by the following Formula 1.

$${R}_{eq} = {\frac{{R}_{μ}}{M} [ 1 + \frac{{σ}^{2}}{{β}^{2}} + \frac{1}{M} {\sum }_{k = 3}^{∞} {( - 1 )}^{k} {( \frac{{Δ}_{q}}{β} )}^{k} ]}^{- 1} . \qquad Formula 1$$

In Formula 1, “Ru” represents the average resistance of all weight units, “σ” represents the standard deviation of the number of weight units with resistance R_{H} in each resistor string, “B” represents the average resistance of all weight units divided by the difference between the resistance R_{H} and the resistance R_{L}, and “Δ_{q}” represents the difference between the number of weight units with resistance R_{H} in each resistor string and the average number of weight units with resistance R_{H} in all resistor strings.

In order to simplify the calculation of Formula 1, in many today's configurations of matrix circuit, the method of increasing “B” (e.g., through the configuration in FIG. 3A) is chosen to simplify Formula 1 into the following Formula 2.

$${R}_{eq} = {\frac{{R}_{μ}}{M} [ 1 + ( approximately 0 ) + ( approximately 0 ) ]}^{- 1} = \frac{{R}_{μ}}{M} . \qquad Formula 2$$

However, as described above, the resistor strings in the conventional configuration of matrix circuits (e.g., the configuration in FIG. 3A) are prone to uneven distribution of resistances. Therefore, the present disclosure chooses to simplify Formula 1 to Formula 2 by reducing “σ”. By reducing “σ”, not only Formula 1 can be simplified, but also the aforementioned uneven distribution of resistances in the resistor strings can be alleviated.

FIGS. 3B-3D are schematic diagrams of the configurations of the status values of the matrix-vector multiplication circuit 200 in accordance with various embodiments of the present disclosure. First, please refer to FIG. 3B. In FIG. 3B, the arrow symbols have two directions (left to right, right to left) and are arranged alternately. Therefore, for the odd-numbered weight values, the bits in the unary code arrays are sequentially represented by the weight units in the resistor strings 210_1-210_5; for the even-numbered weight values, the bits in the unary code arrays are sequentially represented by the weight units in the resistor strings 210_5-210_1.

In other words, the weight units corresponding to the MSBs of the unary code arrays of the odd-numbered weight values and the weight units corresponding to the LSBs of the unary code arrays of the even-numbered weight values are located in the same resistor string, and the weight units corresponding to the MSBs of the unary code arrays of the even-numbered weight values and the weight units corresponding to the LSBs of the unary code arrays of the odd-numbered weight values are located in another same resistor string. Therefore, under the same condition of weight values in FIG. 3A, the sum of the status values of the resistor strings 210_1-210_5 in FIG. 3B is 6, 6, 7, 6 and 7, showing a more even distribution, thereby obtaining more average total resistances to reduce “σ” of Formula 1.

Next, please refer to FIG. 3C. In FIG. 3C, the directions of the arrow symbols are all left to right. What is different from FIG. 3A is that in FIG. 3C, the starting point of the arrow symbol of the weight value is the end point of the arrow symbol of the previous weight value, which means that the configuration of the unary code array is different from that of FIG. 3A. For example, in FIG. 3C, the third weight value is 2, which corresponds to a unary code array “11000”, and the status values of the weight units W_{31_1}-W_{31_3} are configured as 1, 1 and 0 in sequence, and the status values of the weight units W_{31_4} and W_{31_5} are configured as 0, so the LSB at this time corresponds to the resistor string 210_3; the fourth weight value is 1, which corresponds to a unary code array “10000”, the configuration of the weight units at this time will start from the resistor string corresponding to the LSB of the unary code array of the previous weight value (i.e., the resistor string 210_3), and thus the status values of the weight units W_{41_3} and W_{41_4} are configured as 1 and 0 in sequence, and the status values of the weight units W_{41_1}, W_{41_2} and W_{41_5} are configured as 0, so the LSB at this time corresponds to the resistor string 210_4; the fifth weight value is 3, which corresponds to a unary code array “11000”, the configuration of the weight units at this time will start from the resistor string corresponding to the LSB of the unary code array of the previous weight value (i.e., the resistor string 210_4), and thus the status values of the weight units W_{51_4}, W_{51_5}, W_{51_1}, W_{51_2}, and W_{51_3} are configured as 1, 1, 1, 0 and 0 in sequence, and so on.

In other words, the weight unit corresponding to the MSB of the unary code array of the current weight value will be located in the same resistor string as the weight unit corresponding to the LSB of the unary code array of the previous weight value. Therefore, under the same condition of weight values in FIG. 3A, the sum of the status values of the resistor strings 210_1-210_5 in FIG. 3C is 7, 7, 6, 6 and 6, showing a more even distribution, thereby obtaining more average total resistances to reduce “σ” of Formula 1.

Finally, please refer to FIG. 3D. In FIG. 3D, the weight value represents the number of weight units with the status value of 1 in the corresponding combination, and these weight units with the status value of 1 are randomly distributed in their combination (so the weight units with the status value of 1 are not necessarily adjacent). Therefore, under the same condition of weight values in FIG. 3A, the sum of the status values of the resistor strings 210_1-210_5 in FIG. 3D is 7, 7, 7, 6 and 5, showing a more even distribution, thereby obtaining more average total resistances to reduce “σ” of Formula 1.

In conclusion, under the configurations of status values in FIGS. 3B-3D, the MSBs of the unary code arrays of all weight values are located in at least two of the resistor strings 210_1-210_5, so a more average configuration of the total resistance can be obtained (i.e., the standard deviation of the sum of status values is lower, as shown in Table 1 below).

TABLE 1
Weight value: [5, 0, 2, 1, 3, 3, 3, 4, 5, 3, 1, 2]

| | Total status | Average of | Standard deviation |
|---|---|---|---|
| | values of 5 | the total | of the total |
| Configuration | resistor strings | status values | status values |
| FIG. 3A | [11, 9, 7, 3, 2] | 6.4 | 3.34 |
| FIG. 3B | [6, 6, 7, 6, 7] | 6.4 | 0.49 |
| FIG. 3C | [7, 7, 6, 6, 6] | 6.4 | 0.49 |
| FIG. 3D | [7, 7, 7, 6, 5] | 6.4 | 0.8 |

In some embodiments, the matrix-vector multiplication circuit (e.g., the matrix-vector multiplication circuit 100 in FIG. 1) may comprise multiple sets of resistor strings, and each set of resistor strings is configured to process the configuration of a set of weight values. Therefore, the weight values at this time form a matrix instead of an array. This configuration of weight values and matrix-vector multiplication circuit is called a mixing-mode configuration.

For example, Table 2 below lists the weight values of an example matrix-vector multiplication circuit with the mixing-mode configuration, wherein the matrix-vector multiplication circuit comprises eight sets of resistor strings, each set of resistor strings corresponds to 32 weight values, and each weight value is between and inclusive 0 to 3. In addition, Table 3 below lists the configuration, average value and standard deviation of the weight values in Table 2 when using the configurations of FIGS. 3A-3D.

TABLE 2
Weight values of the example matrix-vector multiplication
circuit with the mixing-mode configuration

[1, 2, 0, 0, 2, 3, 1, 2], [0, 0, 2, 0, 1, 0, 2, 2], [3, 0, 1, 0, 3, 2, 0, 0],
[3, 1, 3, 3, 1, 1, 1, 0], [1, 3, 1, 2, 2, 2, 1, 0], [3, 1, 3, 1, 1, 3, 0, 1],
[2, 2, 3, 2, 2, 1, 2, 0], [1, 3, 0, 2, 0, 3, 3, 2], [1, 1, 3, 3, 0, 1, 1, 3],
[1, 2, 2, 2, 0, 1, 3, 2], [2, 3, 1, 0, 2, 2, 1, 0], [2, 3, 0, 1, 1, 1, 2, 2],
[0, 3, 0, 2, 2, 3, 3, 0], [2, 0, 3, 3, 2, 2, 2, 0], [3, 2, 0, 1, 0, 0, 0, 0],
[0, 0, 3, 1, 0, 3, 0, 1], [1, 3, 1, 3, 0, 0, 1, 0], [2, 3, 1, 3, 1, 1, 3, 1],
[1, 0, 1, 1, 3, 3, 3, 1], [1, 1, 2, 2, 3, 0, 1, 1], [1, 3, 3, 0, 0, 3, 3, 2],
[0, 2, 2, 0, 0, 0, 0, 3], [1, 2, 1, 1, 0, 3, 3, 2], [0, 0, 1, 1, 1, 1, 0, 0],
[3, 0, 0, 3, 2, 0, 2, 1], [1, 1, 3, 1, 3, 0, 3, 0], [1, 0, 2, 1, 3, 2, 0, 0],
[2, 3, 3, 0, 0, 3, 1, 2], [2, 2, 0, 1, 3, 3, 3, 0], [1, 1, 0, 0, 0, 3, 1, 3],
[0, 2, 0, 3, 0, 1, 2, 1], [2, 3, 0, 0, 3, 2, 1, 1]

TABLE 3

| | | | Standard |
|---|---|---|---|
| | | Average of | deviation |
| | | the total | of the total |
| | Total status values of 24 | status | status |
| Configuration | resistor strings | values | values |
| FIG. 3A | [27, 14, 6, 25, 19, 11, 23, | 16 | 6.708 |
| | 15, 10, 24, 14, 8, 21, 15, | | |
| | 8, 26, 18, 12, 26, 16, 10, | | |
| | 20, 12, 4] | | |
| FIG. 3B | [17, 14, 16, 18, 19, 18, | 16 | 2.236 |
| | 17, 15, 16, 16, 14, 16, 14, | | |
| | 15, 15, 19, 18, 19, 18, 16, | | |
| | 18, 10, 12, 14] | | |
| FIG. 3C | [16, 16, 15, 19, 18, 18, | 16 | 2.062 |
| | 16, 16, 16, 16, 15, 15, 15, | | |
| | 15, 14, 19, 19, 18, 18, 17, | | |
| | 17, 12, 12, 12] | | |
| FIG. 3D | [15, 17, 15, 16, 19, 20, | 16 | 2.769 |
| | 19, 13, 16, 14, 18, 14, 15, | | |
| | 13, 16, 19, 17, 20, 14, 16, | | |
| | 22, 11, 12, 13] | | |

It can be seen from Table 2 and Table 3 that, similar to Table 1, the standard deviations of the sum of status values obtained by the configurations of FIGS. 3B-3D are also significantly smaller than the standard deviation obtained by the configuration of FIG. 3A.

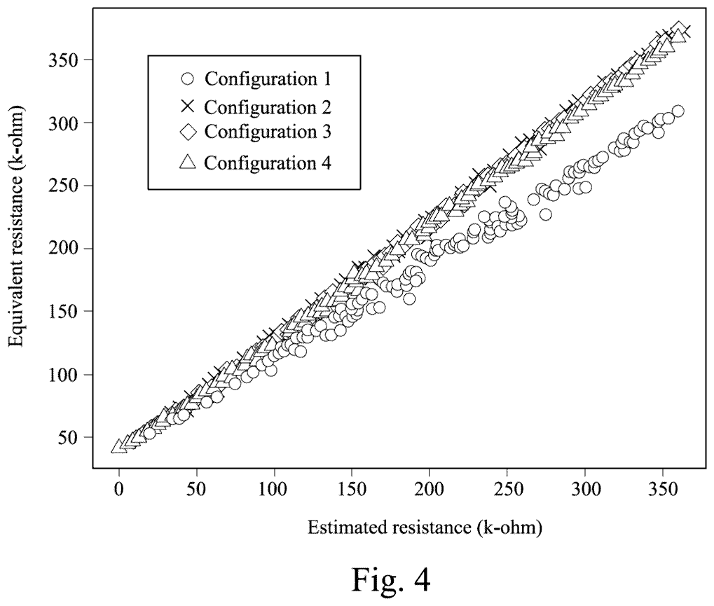

FIG. 4 is a schematic diagram of the relationship between the equivalent resistance (i.e., measured resistance) and the estimated resistance obtained according to the combination of weight values in Table 2 and the configurations of FIGS. 3A-3D in accordance with some embodiments of the present disclosure. It should be noted that for ease of explanation, the configurations in FIGS. 3A-3D are respectively labeled as configurations 1-4 in FIG. 4.

When the measured resistance and the estimated resistance are closer to being equal (i.e., the distribution in the diagram is closer to a straight line with a slope of 1), it means that the linearity obtained by this configuration is better. Therefore, it can be known from FIG. 4 that the linearity obtained by the configurations FIGS. 3B-3D are significantly better than the linearity obtained by the configuration of FIG. 3A.

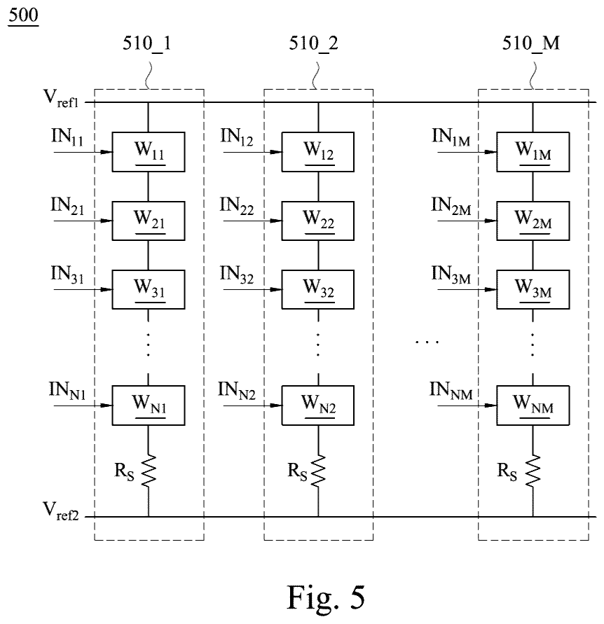

FIG. 5 is a schematic diagram of a matrix-vector multiplication circuit 500 in accordance with some embodiments of the present disclosure. The matrix-vector multiplication circuit 500 is similar to the matrix-vector multiplication circuit 100 in FIG. 1. The difference is that each of the resistor strings 510_1-510_M of the matrix-vector multiplication circuit 500 further comprises an additional resistor R_{S}. The additional resistor R_{S} is coupled in series between the weight units of the resistor string and the reference voltage V_{ref2} to prevent the resistor string from performing fast charging behavior.

In some embodiments, in order for the additional resistor R_{S} to function normally in preventing fast charging behavior, the resistance of the additional resistor R_{S} will be set to one or several times that of the weight unit with higher resistance (e.g., the weight unit with the status value of 1 and the resistance R_{H}), so the resistance of the additional resistor R_{S} is approximately equal to or greater than the resistance of each weight unit in the resistor string.

In some embodiments, each of the weight units has a status value in a multi-bit mode, such as a bit value “0”, a bit value “1”, a bit value “2”, etc. This status value will determine the resistance of the weight unit as R_{L}, R_{H1}, R_{H2}, etc. The resistance of the additional resistor R_{S} will be set to the resistance of the weight unit with a higher resistance, such as R_{H1}, R_{H2}, etc. Therefore, the resistance of the additional resistor R_{S} is approximately equal to or greater than the resistance of each weight unit in its resistor string.

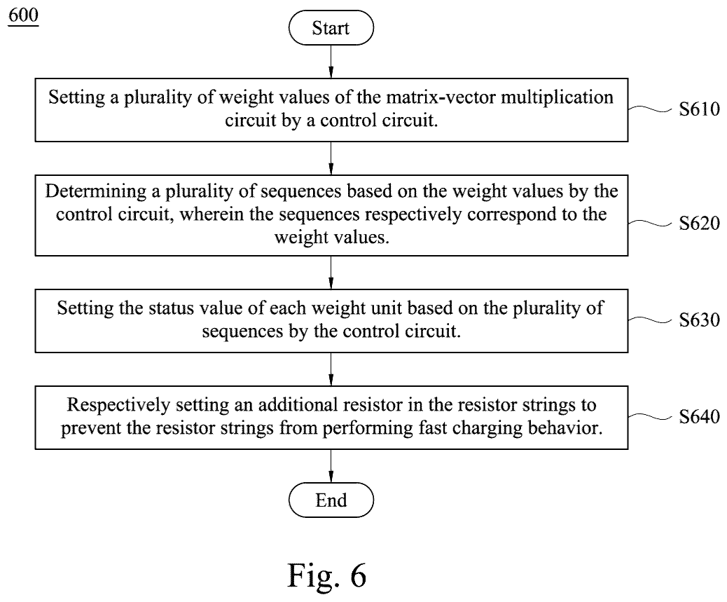

FIG. 6 is a flowchart of a circuit configuring method 600 in accordance with some embodiments of the present disclosure. The circuit configuring method 600 is configured to configure a matrix-vector multiplication circuit (e.g., the matrix-vector multiplication circuits 100, 200 and 500). In some embodiments, the circuit configuring method 600 comprises steps S610, S620, S630 and S640.

In step S610, a plurality of weight values of the matrix-vector multiplication circuit are set by a control circuit (e.g., the control circuit 120). Next, step S620 will be performed.

In step S620, a plurality of sequences are determined by the control circuit based on the plurality of weight values set in step S610. These sequences respectively correspond to the plurality of weight values. Next, step S630 will be performed.

In step S630, a status value of each of the plurality of weight units is set (e.g., by using the configurations of FIGS. 3B-3D) by the control circuit based on the plurality of sequences. Next, step S640 will be performed.

In step S640, an additional resistor is set in each of the plurality of resistor strings to prevent the resistor strings from performing fast charging behavior, and the resistance of the additional resistor is set by the control circuit.

It should be noted that the number and order of steps of the circuit configuring method 600 of the present disclosure are only examples, and are not intended to limit the present disclosure. Other numbers and orders of steps are within the scope of the present disclosure. In some embodiments, step S640 may be performed before step S630. In some embodiments, step S640 may be omitted.

Through the matrix-vector multiplication circuits 100, 200, 500 and the circuit configuring method 600 of the present disclosure, the difference in resistances between the resistor strings can be reduced, thereby improving the linearity of the output of the matrix-vector multiplication circuits. In addition, the additional resistor in the resistor strings can also prevent the resistor strings from performing fast charging behavior, so as to improve the performance of the matrix-vector multiplication circuits.

The above are preferred embodiments of the present disclosure. It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims and their equivalents.

What is claimed is:

1. A matrix-vector multiplication circuit, configured to represent a plurality of weight values and comprising:
a plurality of resistor strings, each of the plurality of resistor strings comprises a plurality of weight units, wherein the plurality of resistor strings are coupled between two reference voltages in parallel, and for each of the plurality of resistor strings, the plurality of weight units are coupled between the two reference voltages in series,
wherein the plurality of weight units form a plurality of combinations corresponding to the plurality of weight values, and for each of the plurality of combinations, the plurality of weight units have the same order in the plurality of resistor strings respectively,
wherein each of the plurality of weight units has a status value, and the plurality of status values of the plurality of weight units in the plurality of combinations form a plurality of sequences respectively corresponding to the plurality of weight values, and
wherein the plurality of weight units corresponding to a plurality of most significant bits of the plurality of sequences are located in at least two of the plurality of resistor strings.

2. The matrix-vector multiplication circuit of claim 1, wherein the plurality of weight units respectively corresponding to the plurality of most significant bits of a plurality of odd sequences of the plurality of sequences are located in one of the plurality of resistor strings, and the plurality of weight units respectively corresponding to the plurality of most significant bits of a plurality of even sequences of the plurality of sequences are located in another of the plurality of resistor strings, and
wherein the plurality of odd sequences are different from the plurality of even sequences.

3. The matrix-vector multiplication circuit of claim 2, wherein the plurality of weight units corresponding to the plurality of most significant bits of the plurality of odd sequences and the plurality of weight units corresponding to a plurality of least significant bits of the plurality of even sequences are located in the same one of the plurality of resistor strings, and
the plurality of weight units corresponding to the plurality of most significant bits of the plurality of even sequences and the plurality of weight units corresponding to a plurality of least significant bits of the plurality of odd sequences are located in another same one of the plurality of resistor strings.

4. The matrix-vector multiplication circuit of claim 2, wherein the plurality of weight units of the plurality of combinations corresponding to the plurality of odd sequences and the plurality of weight units of the plurality of combinations corresponding to the plurality of even sequences are arranged alternately in the plurality of resistor strings.

5. The matrix-vector multiplication circuit of claim 1, wherein each of the plurality of status values of the plurality of weight units is of a bit value “0” or a bit value “1”, and the plurality of weight values correspond to the numbers of the weight unit having the status value of the bit value “1” in the plurality of combinations respectively.

6. The matrix-vector multiplication circuit of claim 5, wherein the plurality of the sequences are of unary code arrays, and each of the plurality of weight values corresponds to the number of the consecutive bit value “1” starting from the most significant bit in corresponding one of the plurality of sequences.

7. The matrix-vector multiplication circuit of claim 6, wherein the weight unit corresponding to a least significant bit of one of the plurality of sequences and the weight unit corresponding to the most significant bit of adjacent one of the plurality of sequences are located in the same one of the plurality of resistor strings.

8. The matrix-vector multiplication circuit of claim 1, further comprising a control circuit configured to generate a plurality of input signals to the plurality of weight units respectively,
wherein each of the plurality of weight units has a resistance related to the status value and related to the plurality of input signals.

9. The matrix-vector multiplication circuit of claim 1, wherein each of the plurality of resistor strings further comprises an additional resistor coupled to the plurality of weight units in series and configured to prevent the plurality of resistor strings from performing fast charging behavior.

10. The matrix-vector multiplication circuit of claim 9, wherein each of the plurality of weight units and the additional resistor has a resistance, and the resistance of the additional resistor is approximately equal to or greater than the resistance of each of the plurality of weight units.

11. A circuit configuring method, configured to configure a matrix-vector multiplication circuit, wherein the matrix-vector multiplication circuit comprises a control circuit and a plurality of resistor strings coupled between two reference voltages in parallel, each of the plurality of resistor strings comprises a plurality of weight units coupled between the two reference voltages in series, wherein the circuit configuring method comprises:
setting, by the control circuit, a plurality of weight values of the matrix-vector multiplication circuit;
determining, by the control circuit, a plurality of sequences based on the plurality of weight values, wherein the plurality of sequences respectively correspond to the plurality of weight values; and
setting, by the control circuit, a status value of each of the plurality of weight units based on the plurality of sequences,
wherein the plurality of weight units form a plurality of combinations corresponding to the plurality of weight values, and for each of the plurality of combinations, the plurality of weight units have the same order in the plurality of resistor strings respectively, and
wherein the plurality of weight units corresponding to a plurality of most significant bits of the plurality of sequences are located in at least two of the plurality of resistor strings.

12. The circuit configuring method of claim 11, wherein determining, by the control circuit, the plurality of sequences based on the plurality of weight values comprises:
dividing, by the control circuit, the plurality of sequences into a plurality of odd sequences and a plurality of even sequences,
wherein the plurality of weight units respectively corresponding to the plurality of most significant bits of the plurality of odd sequences are located in one of the plurality of resistor strings, and the plurality of weight units respectively corresponding to the plurality of most significant bits of the plurality of even sequences are located in another of the plurality of resistor strings, and
wherein the plurality of odd sequences are different from the plurality of even sequences.

13. The circuit configuring method of claim 12, wherein the plurality of weight units corresponding to the plurality of most significant bits of the plurality of odd sequences and the plurality of weight units corresponding to a plurality of least significant bits of the plurality of even sequences are located in the same one of the plurality of resistor strings, and
the plurality of weight units corresponding to the plurality of most significant bits of the plurality of even sequences and the plurality of weight units corresponding to a plurality of least significant bits of the plurality of odd sequences are located in another same one of the plurality of resistor strings.

14. The circuit configuring method of claim 12, wherein the plurality of weight units of the plurality of combinations corresponding to the plurality of odd sequences and the plurality of weight units of the plurality of combinations corresponding to the plurality of even sequences are arranged alternately in the plurality of resistor strings.

15. The circuit configuring method of claim 11, wherein setting, by the control circuit, the status value of each of the plurality of weight units based on the plurality of sequences comprises:
setting, by the control circuit, the plurality of status values of the plurality of weight units to a bit value “0” or a bit value “1”,
wherein the plurality of weight values correspond to the numbers of the weight unit having the status value of the bit value “1” in the plurality of combinations respectively.

16. The circuit configuring method of claim 15, wherein the plurality of the sequences are of unary code arrays, and each of the plurality of weight values corresponds to the number of the consecutive bit value “1” starting from the most significant bit in corresponding one of the plurality of sequences.

17. The circuit configuring method of claim 16, wherein the weight unit corresponding to a least significant bit of one of the plurality of sequences and the weight unit corresponding to the most significant bit of adjacent one of the plurality of sequences are located in the same one of the plurality of resistor strings.

18. The circuit configuring method of claim 11, wherein each of the plurality of weight units has a resistance related to the status value, and setting, by the control circuit, the status value of each of the plurality of weight units based on the plurality of sequences comprises:
generating, by the control circuit, a plurality of input signals to the plurality of weight units, to control the resistance of each of the plurality of weight units.

19. The circuit configuring method of claim 11, wherein each of the plurality of resistor strings further comprises an additional resistor coupled to the plurality of weight units in series, wherein the circuit configuring method further comprises:
setting, by the control circuit, a resistance of the additional resistor, to prevent the plurality of resistor strings from performing fast charging behavior.

20. The circuit configuring method of claim 19, wherein each of the plurality of weight units has a resistance, and the resistance of the additional resistor is approximately equal to or greater than the resistance of each of the plurality of weight units.
